(19) United States
(12) Patent Application Publication
(10) Pub. No.: US 2026/0301077 A1
(43) Pub. Date: Oct. 1, 2026

(54) SYSTEM FOR ANALYSIS OF THE INSURANCE POLICY

(71) Applicant: Shilpa Arora, West Delhi (IN)

(72) Inventor: Shilpa Arora, West Delhi (IN)

(21) Appl. No.: 19/634,374

(22) Filed: Mar. 31, 2026

(30) Foreign Application Priority Data
Mar. 31, 2025 (IN) 202511032163

(51) Int. Cl. G06Q 40/08; G06F 16/34; G06V 30/414

(52) U.S. Cl. CPC G06Q 40/08; G06F 16/345; G06V 30/414

(57) ABSTRACT

The present invention relates to a system for analysis of the insurance policy. The present invention includes a portable computing device (102), and a cloud server computer (110). The portable computing device (102) includes an image capturing device (104), a device processing unit (108), and a portable computing device memory (106). The image capturing device (104) captures image from an insurance policy document. The cloud server computer (110) is connected to the portable computing device (102). The cloud server processor (114) executes computer-readable instructions that uses machine learning model for extracting the details of the insurance policy from the insurance policy document and generates a summary of important features of the insurance policy as well as identify anomaly in the insurance policy and sends same to the portable computing device (102) of a policy holder that helps him to take an informed financial decision.

### FIELD OF THE INVENTION

The present disclosure relates generally to a system for analysis of the insurance policy, and more particularly, to a system and method for providing information from the captured image of insurance and detect anomaly the insurance policy.

### BACKGROUND OF THE INVENTION

A lot of the work that we do today is about information. We research to gather information, and we communicate to share this information. As such, information comes in many forms. Information on paper is often seen as portable, and easy to interface with. Insurance agreement is usually signed in paper format and sometimes signed digitally on digital documents. But often, people lack ability to understand the terms of insurance policy, thus, the people are unable to detect the anomaly in the insurance policy, which costs them at a later stage. Because of the anomaly, people are unable to claim amount. Thus, they need help from the insurance agent to understand insurance policy terms. Also, they are dependent on the agent to detect the anomaly. But there is a chance of human error and also the agent may deceive the policy holder. Thus, there is a need of a system to detect anomaly.

None of the existing prior art/s can overcome the problems associated with reading the scanned document. Existing invention is unable to analyse the content of document, and its context. Hence, there is a need for the present invention.

### OBJECTIVE OF THE INVENTION

The main objective of the present invention is to develop a portable and convenient device, to acquire the information of insurance policy document, and analyse the policy terms.

Yet another objective of the present invention is to provide information from the captured text of the insurance policy document and detect anomaly.

Yet another objective of the present invention is to provide an apparatus that enables users to eliminate the need for agent to analyse the insurance policy.

Yet another objective of the present invention is to provide an apparatus that enables users to claim amount of insurance.

Further objectives, advantages, and features of the present invention will become apparent from the detailed description provided hereinbelow, in which various embodiments of the disclosed invention are illustrated by way of example.

### SUMMARY OF THE INVENTION

The present invention relates to a system for analysis of the insurance policy. The present invention includes a portable computing device, and a cloud server computer. The portable computing device includes an image capturing device, a device processing unit, and a portable computing device memory. The wireless reception device comprises of a battery to provide power, and the portable computing device memory comprises of the computer-readable instructions stored for the execution on the device processing unit. The image capturing device captures image from an insurance policy document. The portable computing device memory stores all the insurance policy documents, computer-readable instructions and images captured from insurance policy documents. The device processing unit is connected to the portable computing device memory and executes computer-readable instructions to capture image from an insurance policy document by using an image capturing device. The cloud server computer is connected to the portable computing device. The cloud server computer includes a cloud database, and a cloud server processor. The cloud database stores all the insurance policy documents, images captured from insurance policy documents, and machine learning model. The cloud server processor executes computer-readable instructions to receive the captured image of the insurance policy document from the portable computing device. The cloud server processor executes computer-readable instructions that uses machine learning model for extracting the details of the insurance policy from the insurance policy documents, and generate a summary of important features the insurance policy as well as identify anomaly in the insurance policy. Then, the cloud server processor sends a summary of important features of the insurance policy, and anomaly in the policy, to the portable computing device of policy holder that helps him in taking informed financial decisions.

The main advantage of the present invention is that the present invention provides a portable and convenient device to acquire the information of insurance policy documents and analyse the policy terms.

Yet another advantage of the present invention is that present invention enables users to eliminate the need for an agent to analyse the insurance policy.

Yet another advantage of the present invention is that present invention enables users to claim amount of insurance.

Further objectives, advantages, and features of the present invention will become apparent from the detailed description provided herein below, in which various embodiments of the disclosed invention are illustrated by way of example.

### BRIEF DESCRIPTION OF THE DRAWINGS

The accompanying drawings are incorporated in and constitute a part of this specification to provide a further understanding of the invention. The drawings illustrate one embodiment of the invention and together with the description, serve to explain the principles of the invention.

FIG. 1 illustrates a system for analysis of the insurance policy.

### DETAILED DESCRIPTION OF THE INVENTION

### Definition

The terms “a” or “an”, as used herein, are defined as one or as more than one. The term “plurality”, as used herein, is defined as two as or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting of” or “consisting of” claim language and is so intended. The term “comprising” is used interchangeably used by the terms “having” or “containing”.

Reference throughout this document to “one embodiment”, “certain embodiments”, “an embodiment”, “another embodiment”, and “yet another embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics are combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

As used herein, the term “one or more” generally refers to, but not limited to, singular as well as the plural form of the term.

The drawings featured in the figures are to illustrate certain convenient embodiments of the present invention and are not to be considered as a limitation to that. The term “means” preceding a present participle of an operation indicates the desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

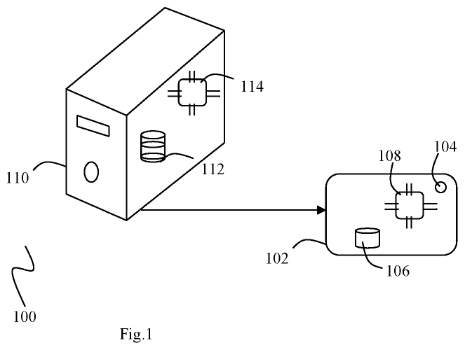

FIG. 1 illustrates a system for analysis of the insurance policy. The present invention includes a portable computing device (102), and a cloud server computer (110). The portable computing device (102) includes an image capturing device (104), a device processing unit (108), and a portable computing device memory (106). The cloud server computer (110) is connected to the portable computing device (102). The cloud server computer (110) includes a cloud database (112), and a cloud server processor (114).

The present invention relates to a system for analysis of the insurance policy. The present invention includes a portable computing device, and a cloud server computer. The portable computing device includes an image capturing device, a device processing unit, and a portable computing device memory. In an embodiment, the portable computing device includes, but are not limited to a tablet, a smartphone, mobile phone, computer and laptop. In the preferred embodiment, the portable computing device is a wireless reception device. The wireless reception device comprises of a battery to provide power, and the portable computing device memory comprises of the computer-readable instructions stored for the execution on the device processing unit. The image capturing device captures images from an insurance policy document. In an embodiment, the image captured from the insurance policy document comprises of a text and symbols. The portable computing device memory stores all the insurance policy documents, computer-readable instructions and images captured from the insurance policy documents. The device processing unit is connected to the portable computing device memory and executes computer-readable instructions to capture images from an insurance policy documents by using an image capturing device. The cloud server computer is connected to the portable computing device. The cloud server computer includes a cloud database, and a cloud server processor. The cloud database stores all the insurance policy documents, images captured from the insurance policy documents, and machine learning model. The cloud server processor executes computer-readable instructions to receive the captured images of the insurance policy document from the portable computing device. The cloud server processor executes computer-readable instructions that uses machine learning model for extracting the details of the insurance policy from the insurance policy document and generate a summary of important features of the insurance policy, as well as identify anomaly in the insurance policy. Then the cloud server processor sends summary of important features of the insurance policy and anomaly in policy, to the portable computing device of policy holder that helps him take informed financial decision. In an embodiment, the cloud server computer is selected from a desktop computer, a server, the mainframe computer.

In embodiment, the present invention relates to a system for analysis of the insurance policy. The present invention includes one or more portable computing devices, and one or more cloud server computers. The one or more portable computing devices include an image capturing device, a device processing unit, and a portable computing device memory. In an embodiment, the one or more portable computing devices include, but are not limited to a tablet, a smartphone, mobile phone, computer and laptop. In the preferred embodiment, the one or more portable computing devices are wireless reception devices. The wireless reception device comprises of a battery to provide power, and the portable computing device memory comprises of the computer-readable instructions stored for the execution on the device processing unit. The image capturing device, captures image from an insurance policy document. In an embodiment, the image captured from the insurance policy document comprises of text and symbols. The portable computing device memory stores all the insurance policy documents, computer-readable instructions and images captured from insurance policy documents. The device processing unit is connected to the portable computing device memory, and executes computer-readable instructions to capture image from an insurance policy document by using an image capturing device. The one or more cloud server computers are connected to the one or more portable computing devices. The one or more cloud server computers include a cloud database, and a cloud server processor. The cloud database stores all the insurance policy documents, image/s captured from insurance policy documents and machine learning model. The cloud server processor executes computer-readable instructions to receive the captured image of the insurance policy document from the one or more portable computing devices. The cloud server processor executes computer-readable instructions that uses machine learning model for extracting the details of the insurance policy from the insurance policy document, and generate a summary of the important features of the insurance policy, as well as identify anomaly in the insurance policy. Then the cloud server processor sends summary of important features of the insurance policy and anomaly in policy to the one or more portable computing devices of the policy holder that helps him take informed financial decision. In an embodiment, the one or more cloud server computers are selected from a desktop computer, a server, the mainframe computer.

In an embodiment, the present invention relates to a method for capturing and processing the image from the insurance policy document, the method includes: the portable computing device displaying instructions to enter the policy holder's details and option to capture the image or upload the insurance policy document;
the image capturing device captures the image, and the device processing unit stores the image in portable computing device memory and sends captured image to the cloud server computer;
the cloud server processor executes computer-readable instructions to remove the noise from the image that is being captured;
the cloud server processor executes computer-readable instructions to enhance contrast to make subtle features selected from text and symbols clearly visible for contextual information related to the captured image;
the cloud server processor executes computer-readable instructions to de-skew the image of the insurance policy document;
the cloud server processor executes computer-readable instructions to split pages of the insurance policy document;
the cloud server processor executes computer-readable instructions to mark check boxes on pages of the insurance policy document; and
the cloud server processor executes computer-readable instructions to perform optical character reading on all pages of the insurance policy document. In an embodiment, the present invention relates to method for analysis of the insurance policy document, the method includes:
the cloud server processor executing computer-readable instructions to perform extraction of the data from all the pages of the insurance policy document;
the cloud server processor executes computer-readable instructions that uses machine learning model to understand the text and context of the terms in the insurance policy document,
the cloud server processor executes computer-readable instructions that used machine learning model to analyses information, and arrange the same in a table with corresponding questions about the insurance policy;
the cloud server processor executes computer-readable instructions that used machine learning model, that provide the important insight about the insurance policy, and identify the defect in the insurance policy.

In the preferred embodiment, the machine learning model provides insights related to Declaration about Pre-existing Medical Conditions, Lifestyle Habits such as smoking, alcohol consumption, Room Rent, ICU, and Ambulance Charges, Sub-limits, Co-pays and Waiting Period, Maternity Benefits, Health Check-Ups, Hospital Daily Cash and Personal Accident Cover, OPD Coverage, Pre & Post Hospitalization Coverage, Modern treatments and List of Exclusions. In the preferred embodiment, the cloud server processor uses natural language processing, convolutional neural network, to extract information from image that is being captured, and analyse information related to insurance policy.

In an embodiment, the present invention relates to a method of capturing and processing the image/s from the insurance policy documents, the method includes: the one or more portable computing devices displaying instructions to be entered by the policy holder, details and options to capture the image or upload the insurance policy document;
the image capturing device captures the image, and the device processing unit stores the image in portable computing device memory and sends captured image to the one or more cloud server computers;
the cloud server processor executes computer-readable instructions to remove the noise from the image that is being captured;
the cloud server processor executes computer-readable instructions to enhance contrast to make subtle features selected from text and symbols clearly visible for contextual information related to the captured image;
the cloud server processor executes computer-readable instructions to de-skew the image of the insurance policy document;
the cloud server processor executes computer-readable instructions to split pages of the insurance policy document;
the cloud server processor executes computer-readable instructions to mark check boxes on the pages of the insurance policy document; and
the cloud server processor executes computer-readable instructions to perform optical character recognition on all pages of the insurance policy document.

In an embodiment, the present invention relates to a method for analysis of the insurance policy document, the method includes:
the cloud server processor executes computer-readable instructions to perform extraction of data from all pages of the insurance policy document;
the cloud server processor executes computer-readable instructions that uses machine learning model to understand the text and context of the terms in the insurance policy document,
the cloud server processor executes computer-readable instructions that uses machine learning model to analyse information and arrange the same in tables with corresponding questions about the insurance policy;
the cloud server processor executes computer-readable instructions that uses machine learning model and provide important insights about the insurance policy and identify defects in the insurance policy.

In the preferred embodiment, the machine learning model provides insights related to Declaration about Pre-existing Medical Conditions, Lifestyle Habits such as smoking, alcohol consumption, Room Rent, ICU, and Ambulance Charges, Sub-limits, Co-pays and Waiting Period, Maternity benefits, Health Check-Ups, Hospital Daily Cash and Personal Accident Cover, OPD Coverage, Pre & Post Hospitalization Coverages, Modern treatments and List of Exclusions. In the preferred embodiment, the cloud server processor uses natural language processing, convolutional neural network to extract information from image that is being captured and analyse information related to insurance policy.

1. A system (100) for providing analysis of the insurance policy, the system (100) comprises:
and at least one portable computing device (102), the at least one portable computing device (102) having
an image capturing device (104), the image capturing device (104) captures image from an insurance policy document,
a portable computing device memory (106), the portable computing device memory (106) stores an insurance policy document, computer-readable instructions and image captured from insurance policy document, and
a device processing unit (108), the device processing unit (108) is connected to the portable computing device memory (106) and executes computer-readable instructions to capture image from an insurance policy document by using an image capturing device (104); and
an at least one cloud server computer (110), the at least one cloud server computer (110) is connected to the at least one portable computing device (102), the at least one cloud server computer (110) having
a cloud database (112), the cloud database (112) stores all the insurance policy document, image captured from insurance policy document and machine learning model, and
a cloud server processor (114), the cloud server processor (114) executes computer-readable instructions to receive the captured image of the insurance policy document from the at least one portable computing device (102);
characterized in that, the cloud server processor (114) executes computer-readable instructions that uses machine learning model for extracting the details of the insurance policy from the insurance policy document and generate a summary of the important features of the insurance policy as well as identify anomaly in the insurance policy, then the cloud server processor (114) sends a summary of the important features of the insurance policy and anomaly in the policy to at least one portable computing device (102) of policy holder that helps him to take informed financial decision.

2. The system as claimed in claim 1, wherein the at least one portable computing device (102) is a wireless reception device, wherein, the wireless reception device comprises of a battery to provide power and the portable computing device memory (106) comprises of the computer-readable instructions stored for the execution on the device processing unit (108).

3. The system (100) as claimed in claim 1, wherein the at least one portable computing device (102) is selected from a tablet, a smartphone, mobile phone, computer, and laptop.

4. The system (100) as claimed in claim 1, wherein, the image captured from the insurance policy document comprises of a text and symbols.

5. The system (100) as claimed in claim 1, wherein the at least cloud server computer (102) is selected from a desktop computer, a server, a mainframe computer.

6. A method for capturing and processing the image from the the insurance policy document by using the system (100) as claimed in claim 1, the method comprising:
the at least one portable computing device (102) displays instructions to enter the policy holder details and an option to capture the image or upload the insurance policy document;
the image capturing device (104) captures the image and the device processing unit (108) stores the image in portable computing device memory (106) and sends captured image to the at least one cloud server computer (110);
the cloud server processor (114) executes computer-readable instructions to remove the noise from the image that is being captured;
the cloud server processor (114) executes computer-readable instructions to enhance contrast to make subtle features selected from text and symbols are clearly visible for contextual information related to the captured image;
the cloud server processor (114) executes computer-readable instructions to de-skew the image of the insurance policy document;
the cloud server processor (114) executes computer-readable instructions to split pages of the insurance policy document;
the cloud server processor (114) executes computer-readable instructions to mark check boxes on the pages of the insurance policy document; and
the cloud server processor (114) executes computer-readable instructions to perform optical character recognition on all pages of the insurance policy document.

7. A method for analysis of the insurance policy document by using the system (100) as claimed in claim 1, the method comprising:
the cloud server processor (114) executes computer-readable instructions to perform extraction of data from all pages of the insurance policy document;
the cloud server processor (114) executes computer-readable instructions that uses machine learning model to understand the text and context of the terms in the insurance policy document,
the cloud server processor (114) executes computer-readable instructions that uses machine learning model to analyse information and arrange the same into tables with corresponding questions about the insurance policy;
the cloud server processor (114) executes computer-readable instructions that uses machine learning model that provides important insights about the insurance policy and identify the defect in the insurance policy.

8. The method claimed in claim 7, wherein machine learning model provides insights related to Declaration about Pre-existing Medical Conditions, Lifestyle Habits such as smoking, alcohol consumption, Room Rent, ICU, and Ambulance Charges, Sub-limits, Co-pays and Waiting Period, Maternity benefits, Health Check-Ups, Hospital Daily Cash and Personal Accident Cover, OPD Coverage, Pre & Post Hospitalization Coverages, Modern treatments and List of Exclusions.

9. The system (100) as claimed in claim 1, wherein, the cloud server processor (114) uses natural language processing, convolutional neural network to extract information from image that is being captured and analyse information related to insurance policy.
